(19) United States
(12) Patent Application Publication
(10) Pub. No.: US 2003/0015604 A1
(43) Pub. Date: Jan. 23, 2003

(54) Nozzle to promote flat fluid stream

(76) Inventors: William Thoru Kobayashi, Somers, NY (US); Nelson Seiji Yokaichiya, Sao Paulo (BR)

Correspondence Address: PRAXAIR, INC., LAW DEPARTMENT - M1 557, 39 OLD RIDGEBURY ROAD, DANBURY, CT, 06810-5113, US

(21) Appl. No.: 09/906,664

(22) Filed: Jul. 18, 2001

(51) Int. Cl. B05B 1/28

(52) U.S. Cl. 239/299; 239/296; 239/419.3; 239/482

(57) ABSTRACT

A nozzle comprises a nozzle body, a principal orifice, annular orifice means in the front of the nozzle body for atomizing the stream ejected from the principal orifice, a pair of flattening orifice means in the front of the nozzle body for flattening the atomized stream, secondary orifice means in the front of the nozzle body for widening the flattened stream, and conduit means communicating between the back of the nozzle body and, respectively, said principal orifice means, said annular orifice, said flattening orifice means, and said secondary orifice means.

### FIELD OF THE INVENTION

The present invention relates to a nozzle useful in forming a flat, wide stream of fuel such as fuel oil to aid in the combustion thereof.

### BACKGROUND OF THE INVENTION

In the operation of furnaces and similar equipment which combust fuel to e.g. generate heat, the art has long recognized the value of atomizing the fuel, particularly where the fuel is liquid. Atomizing, by which is meant converting a stream of fuel into small droplets, aids in obtaining more complete combustion than would otherwise be the case, and is often necessary to achieve combustion at all. One manner of achieving atomization of fuel is to eject a stream of the fuel from a suitably configured nozzle, and simultaneously to cause one or more jets of atomizing fluid, particularly compressed air, to impinge onto the stream of fuel in a manner that causes the stream of fuel to be atomized. Such techniques have drawbacks, particularly when the fuel is particularly high viscosity fuel oil. For instance, poor interaction between the atomizing fluid and the stream of fuel leads to poor atomization, and consequent loss of efficiency of combustion and increased emission of pollutants such as carbon monoxide. In addition, poorly designed atomization leads to the formation of deposits such as coke on surfaces of the nozzle or burner. These represent also loss of efficiency of combustion, and also lead to mechanical breakdown of the nozzle and burner assembly because of the accumulating amounts of these solid coke deposits.

Thus, there remains a need for a more efficient and effective nozzle and burner assembly in which a stable, highly efficient flame can be established and controlled, especially when the fuel is a liquid such as fuel oil.

### BRIEF SUMMARY OF THE INVENTION

One aspect of the present invention is a nozzle comprising

(A) a nozzle body having a front and a back;

(B) a principal orifice situated in the front of the nozzle body and having a principal orifice axis;

(C) annular orifice means in the front of the nozzle body and annular to the principal orifice;

(D) a pair of flattening orifice means in the front of the nozzle body and situated on opposing sides of a first plane in which the principal orifice axis lies, each of said flattening orifice means having an axis converging toward said first plane, wherein the peripheral edge of each flattening orifice means lies in one plane, and the axis of each flattening orifice means is perpendicular to the plane in which said edge lies;

(E) secondary orifice means in the front of the nozzle body and situated on opposing sides of said first plane, each of said orifice means having an axis whose projection in said first plane forms an angle of 5° to 90° with said principal orifice axis and whose projection in a second plane that contains said principal orifice axis and that is perpendicular to said first plane forms an angle of 50 to 90°. with said principal orifice axis;

(F) principal conduit means within said nozzle body communicating between the back of the nozzle body and said principal orifice; and

(G) branched conduit means within said nozzle body which communicates at one end with the back of the nozzle body and which communicates with said annular orifice, said flattening orifice means, and said secondary orifice means.

Another aspect of the present invention is a process for atomizing fuel, which establishes said atomized fuel in a flat pattern exhibiting an angle of at least 15° with respect to the axis thereof, comprising

(A) ejecting a stream of fuel from a principal orifice in a nozzle body, said principal orifice having an axis;

(B) atomizing said fuel by ejecting atomizing fluid toward said ejected stream of fuel from annular orifice means in the front of the nozzle body and which is annular to the principal orifice;

(C) flattening the pattern formed by said atomized fuel by ejecting flattening fluid toward said atomized fuel from a pair of flattening orifice means in the front of the nozzle body and situated on opposing sides of a first plane in which the principal orifice axis lies, each of said flattening orifice means having an axis converging toward said first plane, wherein the peripheral edge of each flattening orifice means lies in one plane, and the axis of each flattening orifice means is perpendicular to the plane in which said edge lies; and

(D) widening the angle of the flattened pattern of fuel compared to the angle formed by said flattening without said widening, by ejecting fluid into and parallel to the area outside the outer peripheral edges of said flattened pattern from pairs of secondary orifice means in the front of the nozzle body and situated on opposing sides of said first plane, each of said pair having an axis whose projection in said first plane forms an angle of 5° to 90° with said principal orifice axis and whose projection in a second plane that contains said principal orifice axis and is perpendicular to said first plane forms an angle of 5° to 90° with said principal orifice axis.

### BRIEF DESCRIPTION OF THE DRAWINGS

FIG. 1 is a cross-sectional side view of a nozzle in accordance with the present invention.

FIG. 2 is a cross-sectional side view of the portion of the nozzle of FIG. 1 closer to the end thereof.

FIG. 3 is a top plan view of the nozzle portion depicted in FIG. 2.

FIG. 4 is a front plan view of the nozzle.

### DETAILED DESCRIPTION OF THE INVENTION

The invention will first be described with reference to the attached drawing figures, although it should be recognized that the drawings and the description based thereon should not be construed as limiting that which is considered to be the scope of the present invention.

Nozzle body 1 includes back 2 and front 3. The nozzle body can be formed of any material capable of withstanding the temperatures typically generated upon combustion of hydrocarbon fuel in a flame emanating from front 3. Suitable materials include refractory materials such as ceramic, alumina, and the like, as well as metal and metal alloys. The nozzle body exhibiting the characteristics described herein can be one unitary piece or can be formed from two separate pieces which are then assembled, generally in a concentric manner. The nozzle body is preferably circular in cross-section, but may have other configurations provided that the functions herein are accomplished.

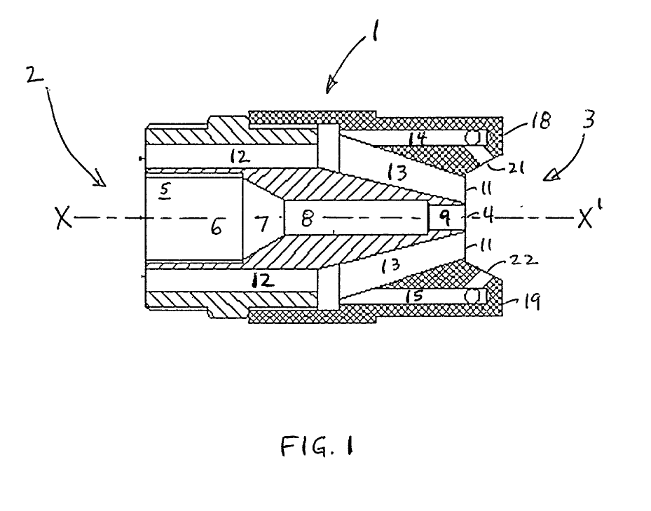

The nozzle body 1 includes a principal orifice 4 in the front of the nozzle body. Principal orifice 4 communicates with the back 2 via principal conduit 5 (successive sections of which appear in FIG. 1 as reference numerals 6, 7, 8 and 9) which extends through the nozzle body from the back 2 to the front 3 and terminates in principal orifice 4. The principal orifice 4 and the principal conduit 5 are preferably coaxial and concentric about principal orifice axis X-X′.

As used herein, the “axis” of an orifice is used to denote the centerline of the direction in which fluid flows as it is ejected from the orifice. This direction is determined by the shape and the orientation of the orifice and of the associated conduit as it meets the orifice. Preferably, an orifice and its associated conduit are coaxial at least at the area where the conduit terminates at the orifice.

The specific geometry of the principal conduit, consistent with the foregoing, can vary somewhat but it is typical to provide that the diameter of the principal conduit decreases in a downstream direction (i.e. proceeding from the back 2 toward and out of the principal orifice 4). One typical embodiment is shown in FIG. 1, including a portion 6 of relatively larger diameter, a uniformly tapering portion 7, a portion 8 of narrower diameter than the diameter of portion 6, portion 9 of a diameter yet less than the diameter of portion 8, and the like. The last portion 9 which terminates in principal orifice 4 preferably has a constant diameter or can be diverging or converging in the direction of fluid flow. For ease of construction and of control in operation, the sections 6-7-8-9 of the principal conduit are preferably circular in cross-section, although other configurations may be employed to similar effect.

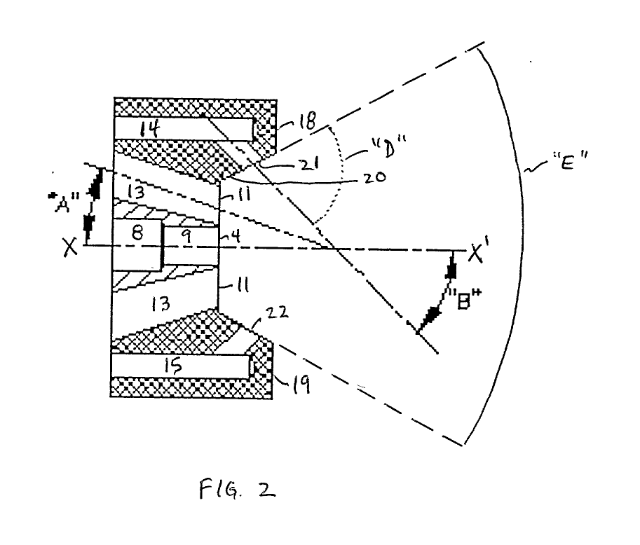

Nozzle body 1 further includes annular orifice 11. It surrounds orifice 4 and is coaxial therewith. The annular orifice 11 is angled so that fluid ejected from it forms a cone whose angle of rotation is 15° to 45°, and preferably 15° to 30°, relative to axis X-X′ which is the principal orifice axis. This angle is shown as angle “A” in FIG. 2.

The mouth (as distinguished from the axis) of annular orifice 11 can be in the same plane as that of principal orifice 4, as shown in FIGS. 1 and 2. In the embodiment depicted in FIGS. 1 and 2, the adjacent edges of the principal orifice and the annular orifice intersect as a sharp edge. This is preferred because it presents minimum surface area between orifice 4 and orifice 11, thereby minimizing the opportunity for carbon deposits to form between those orifices.

The annular orifice 11 is located and configured so that gas being ejected therefrom will impinge on and atomize a fuel stream being ejected out of principal orifice 4.

Nozzle body 1 also contains flattening orifice means. Preferably, as shown in the Figures, the flattening orifice means comprises orifices 21 and 22 although other configurations (such as replacing each of said orifices with two diverging orifices) are possible. Referring to FIGS. 1 and 2, orifices 21 and 22 are situated on opposing sides of an imaginary first plane in which the axis X-X′ lies. Preferably they are equidistant from the axis X-X′ of principal orifice 4.

The axes of orifices 21 and 22 converge toward axis X-X′, and are directed toward said first plane in which the atomized, spreading fuel pattern is formed. More specifically, as can be seen in FIG. 2, the projection of the axis of each orifice 21 and 22 in a plane that is perpendicular to the aforementioned imaginary first plane, and that also contains the axis X-X′ of the principal orifice 4, forms an angle to axis X-X′ (seen as angle B) which is 5° to 90° and is more preferably 30° to 80°. The flattening orifices such as orifices 21 and 22 are preferably located such that they are downstream from orifice 4; that is, lines normal to axis X-X′ and passing respectively through the centers of orifices 21 and 22 intersect axis X-X′ downstream from orifice 4.

The peripheral edge of each flattening orifice should lie all in one plane, and the axis of each flattening orifice should be perpendicular to the plane in which the flattening orifice's peripheral edge lies. That is, angle “D” in FIG. 2 should be about 90°. Also, the surfaces of the nozzle body surrounding the flattening orifices such as orifices 21 and 22 should form an angle seen as angle “E” in FIG. 2, which is a function of angle “B” and can be calculated as E=180°−2B.

The flattening orifices are situated and oriented so that fluid ejected therefrom impinges on the atomized fuel stream, and flattens and spreads out the pattern formed by the atomized stream being ejected from principal orifice 4 and atomized by fluid ejected from annular orifice 11. Preferably, where there are two flattening orifices, a line connecting them intersects and is perpendicular to the axis X-X′.

Nozzle body 1 also contains secondary orifice means situated on opposing sides of the aforementioned first plane that contains axis X-X′. Preferably they are equidistant from the axis of principal orifice 4. While other arrangements are possible, a preferred arrangement comprises a pair of secondary orifices 23 and 24 on one side of that first plane, and a second pair of secondary orifices 25 and 26 on the other side of that first plane.

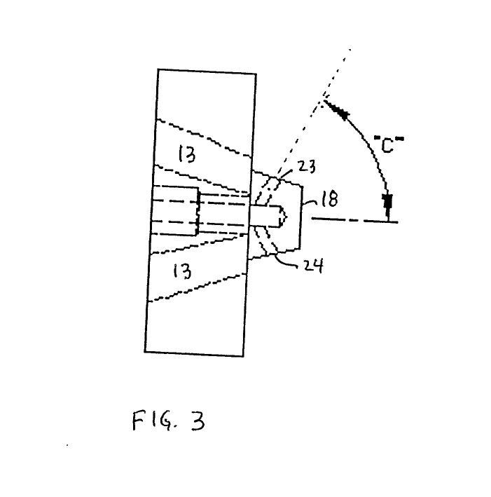

The axes of secondary orifices 23 and 24 diverge from each other and from the axis of the principal orifice in a downstream direction, and are directed toward the aforementioned first plane in which the atomized, spreading fuel pattern is formed. More specifically, as can be seen in FIG. 3, the projection of the axis of each secondary orifice 23 and 24 in said first plane forms an angle with axis X-X′ (seen as angle C) of 5° to 90° and more preferably 30° to 80°. Also, the projection of the axis of each secondary orifice 23 and 24 in a second plane which contains axis X-X′ and which is perpendicular to said first plane forms an angle with axis X-X′ which is 50 to 90° and is more preferably of 30° to 80°. Orifices 25 and 26 are oriented in the same way as orifices 23 and 24, except on the other side of said first plane.

The fluid ejected from these secondary orifice means is directed so as to widen the angle formed by the spreading atomized fuel. Preferably, this is achieved by directing the fluid from these orifices to the region immediately outside the outer peripheral edges of the fuel pattern, thereby to draw the atomized fuel outward further than could be achieved simply through use of the flattening orifices.

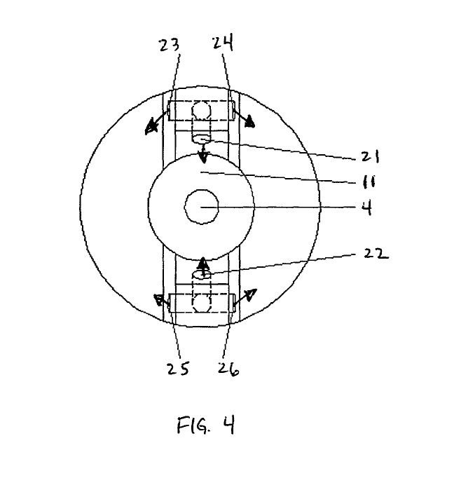

Referring to FIG. 4, which shows the view looking at the front of the nozzle, fuel emerges from orifice 4 perpendicularly outward from the page towards the viewer. Atomizing fluid is directed out of the page from orifice 11, in a cone-shaped pattern converging on the stream of fuel. Flattening fluid emerges from orifices 21 and 22 in the direction of the arrows, and also out of the page. Fluid emerges from orifices 23-26 in the direction of the arrows, and also out of the page.

Nozzle body 1 further includes conduit 12 extending into nozzle body 1 from back 2. Conduit branch 13 branches from conduit 12 and communicates with the annular orifice 11. Conduit branch 14 extends from conduit 12 and communicates with orifices 21, 23 and 24, generally via separate short branches each extending from branch 14. In an analogous manner, branch 15 leads to separate short branches that communicate to orifices 22, 25 and 26. The secondary orifices and the conduits leading to them can be of constant cross-sectional shape and area or can, if desired, be provided with varying configurations to converge or diverge in the direction of fluid flow.

To achieve the desired flows and the desired atomization and flattening of the stream ejected from principal orifice 4, it is preferred to maintain certain dimensional relationships and stream flow rates. For instance, the cross-sectional area of the annular orifice 11, divided by the sum of the cross-sectional areas of all the flattening orifices should be within the range of 1 to 5 and preferably from 1 to 3.

The ratio of the sum of the cross-sectional areas of the secondary orifices to the sum of (the cross-sectional area of the annular orifice plus the cross-sectional areas of all the flattening orifices) should be from 0.2 to 5, and preferably from 0.25 to 2.

In operation of the nozzle, the end of the principal conduit 5 at the back of the nozzle body is connected to a source of fuel, such as liquid oil or fuel gas, and the back end of the conduit 12 is connected to a source of air or other atomizing fluid. Atomizing fluid can be inert or reactive, and can be any product in the gaseous phase that can be supplied at the atomizing fluid inlet at adequate pressure and temperature.

The fluid that flows through principal orifice 4 can be liquid fuel (examples of which are fuel oil or any other liquid fuel) or gaseous fuel (examples of which include natural gas, propane, butane, or any other gaseous fuel, including mixtures of any of the foregoing). In addition, the fluid fed through orifice 4 could be any liquid that benefits from being atomized in a flat jet or stream, such as contaminated aqueous fluid in incineration applications. Gaseous atomizing fluid flows through the annular orifice 11, the flattening orifices and the secondary orifices 23-26. In other applications fuel gas can be passed through the annular orifice 11 and/or the secondary orifices 23-26. Any type of gaseous fluid can be passed through the secondary orifices such as oxygen, compressed air, blown air, steam, nitrogen, argon or any fuel gas, including mixtures of any of the foregoing.

Suitable controls are provided to regulate the mass flow rates and velocities of each of the streams emanating through each orifice. The atomizing fluid (or stabilizing fluid) velocity must be ejected from orifices 11 and 21-26 at a velocity within the range of from 0.01 to 1.5 Mach, with a higher value in this range preferred for atomization and a lower value within this range for stabilization. Preferably, the velocity is within the range of 0.01 to 1.0 Mach.

When the fuel is liquid, such as fuel oil, the mass ratio of atomizing fluid to liquid fuel flow should be in the range of from 0.2:1 to 1:1, and preferably within the range of 0.3:1 to 0.7:1. The liquid fuel velocity should be within the range of 1.5 to 20 meters per second. When the fuel is gaseous, its velocity should be within the range of 0.01 to 1.5 Mach, and preferably from 0.1 to 1.0 Mach. The exit velocity of the fluid through the flattening and secondary orifices 21-26 is preferably within the range of from 0.01 to 1 Mach, and more preferably from 0.01 to 0.9 Mach.

What is claimed is:

1. A nozzle comprising
(A) a nozzle body having a front and a back;
(B) a principal orifice situated in the front of the nozzle body and having a principal orifice axis;
(C) annular orifice means in the front of the nozzle body and annular to the principal orifice;
(D) a pair of flattening orifice means in the front of the nozzle body and situated on opposing sides of a first plane in which the principal orifice axis lies, each of said flattening orifice means having an axis converging toward said first plane, wherein the peripheral edge of each flattening orifice means lies in one plane, and the axis of each flattening orifice means is perpendicular to the plane in which said edge lies;
(E) secondary orifice means in the front of the nozzle body and situated on opposing sides of said first plane, each of said orifice means having an axis whose projection in said first plane forms an angle of 5° to 90° with said principal orifice axis and whose projection in a second plane that contains said principal orifice axis and that is perpendicular to said first plane forms an angle of 5° to 90° with said principal orifice axis;
(F) principal conduit means within said nozzle body communicating between the back of the nozzle body and said principal orifice; and
(G) branched conduit means within said nozzle body which communicates at one end with the back of the nozzle body and which communicates with said annular orifice, said flattening orifice means, and said secondary orifice means.

2. A nozzle according to claim 1 wherein the annular orifice is angled so that fluid ejected from it forms a cone whose angle of rotation is 15° to 45° relative to the principal orifice axis.

3. A nozzle according to claim 1 wherein the edges of said principal orifice and of said annular orifice intersect at a sharp edge.

4. A nozzle according to claim 1 wherein the projection of the axis of each flattening orifice means in a plane that is perpendicular to said first plane, and that also contains the principal orifice axis forms an angle to the principal orifice axis which is 5° to 90°.

5. A nozzle according to claim 1 wherein the cross-sectional area of the annular orifice divided by the sum of the cross-sectional areas of all the flattening orifice means is within the range of 1 to 5.

6. A nozzle according to claim 1 wherein the ratio of the sum of the cross-sectional areas of all the secondary orifice means to the sum of the cross-sectional area of the annular orifice plus the cross-sectional areas of all the flattening orifice means is 0.2 to 5.

7. A nozzle according to claim 1 wherein the annular orifice is angled so that fluid ejected from it forms a cone whose angle of rotation is 15° to 45° relative to the principal orifice axis, the edges of said principal orifice and of said annular orifice intersect at a sharp edge, the projection of the axis of each flattening orifice means in a plane that is perpendicular to said first plane, and that also contains the principal orifice axis, forms an angle to the principal orifice axis which is 5° to 90°, the cross-sectional area of the annular orifice divided by the sum of the cross-sectional areas of all the flattening orifice means is within the range of 1 to 5, and the ratio of the sum of the cross-sectional areas of all the secondary orifice means to the sum of the cross-sectional area of the annular orifice plus the cross-sectional areas of all the flattening orifice means is 0.2 to 5.

8. A process for atomizing a fluid, comprising
(A) ejecting a stream of said fluid from a principal orifice in a nozzle body, said principal orifice having an axis;
(B) atomizing said fluid by ejecting atomizing fluid toward said ejected stream of fluid from annular orifice means in the front of the nozzle body which is annular to the principal orifice;
(C) flattening the pattern formed by said atomized fluid by ejecting flattening fluid toward said atomized fluid from a pair of flattening orifice means in the front of the nozzle body and situated on opposing sides of a first plane in which the principal orifice axis lies, each of said flattening orifice means having an axis converging toward said first plane, wherein the peripheral edge of each flattening orifice means lies in one plane, and the axis of each flattening orifice means is perpendicular to the plane in which said edge lies; and
(D) widening the angle of the flattened pattern of fluid compared to the angle formed by said flattening without said widening, by ejecting widening fluid into and parallel to the area outside the outer peripheral edges of said flattened pattern from pairs of secondary orifice means in the front of the nozzle body and situated on opposing sides of said first plane, each of said pair having an axis whose projection in said first plane forms an angle of 5° to 90° with said principal orifice axis and whose projection in a second plane that contains said principal orifice axis and is perpendicular to said first plane forms an angle of 5° to 90° with said principal orifice axis.

9. A process according to claim 8 wherein the annular orifice is angled so that fluid ejected from it forms a cone whose angle of rotation is 15° to 45° relative to the principal orifice axis.

10. A process according to claim 8 wherein the edges of said principal orifice and of said annular orifice intersect at a sharp edge.

11. A process according to claim 8 wherein the projection of the axis of each flattening orifice means in a plane that is perpendicular to said first plane, and that also contains the principal orifice axis forms an angle to the principal orifice axis which is 5° to 90°.

12. A process according to claim 8 wherein the cross-sectional area of the annular orifice divided by the sum of the cross-sectional areas of all the flattening orifice means is within the range of 1 to 5.

13. A process according to claim 8 wherein the ratio of the sum of the cross-sectional areas of all the secondary orifice means to the sum of the cross-sectional area of the annular orifice plus the cross-sectional areas of all the flattening orifice means is 0.2 to 5.

14. A process according to claim 8 wherein the annular orifice is angled so that fluid ejected from it forms a cone whose angle of rotation is 15° to 45° relative to the principal orifice axis, the edges of said principal orifice and of said annular orifice intersect at a sharp edge, the projection of the axis of each flattening orifice means in a plane that is perpendicular to said first plane, and that also contains the principal orifice axis, forms an angle to the principal orifice axis which is 5° to 90°, the cross-sectional area of the annular orifice divided by the sum of the cross-sectional areas of all the flattening orifice means is within the range of 1 to 5, and the ratio of the sum of the cross-sectional areas of all the secondary orifice means to the sum of the cross-sectional area of the annular orifice plus the cross-sectional areas of all the flattening orifice means is 0.2 to 5.

15. A process according to claim 8 wherein the fluid being atomized is liquid fuel.

16. A process according to claim 8 wherein the fluid being atomized is gaseous fuel.
